(19) United States
(12) Patent Application Publication
(10) Pub. No.: US 2026/0031578 A1
(43) Pub. Date: Jan. 29, 2026

(54) ELECTROMAGNETIC SHIELDING BODY FOR AN ELECTRICAL SIGNAL AND/OR DATA AND/OR RADIOFREQUENCY (RF) SIGNAL TRANSMISSION CONNECTOR, COMPRISING RADIALLY FLEXIBLE TABS WITH TWO DIFFERENT PROFILES, INCLUDING ONE WITH A BUMP INTENDED TO FORM A POINT OF ELECTRICAL CONTACT

(71) Applicant: RAYDIALL S.A.S., VOIRON (FR)

(72) Inventors: Sébastien ANNEQUIN, SAINT NICOLAS DE MACHERIN (FR); Emilien MARGULIS, SEREZIN DE LA TOUR (FR)

(21) Appl. No.: 19/277,656

(22) Filed: Jul. 23, 2025

(30) Foreign Application Priority Data
Jul. 25, 2024 (FR) 2408284

(51) Int. Cl. H01R 13/6592; H01R 13/02; H01R 13/415; H01R 13/6598

(52) U.S. Cl. CPC H01R 13/6592; H01R 13/025; H01R 13/415; H01R 13/6598

(57) ABSTRACT

The application relates to an electrically conductive body having a longitudinal axis (X), forming an electromagnetic shielding body for a connector for the transmission of electrical signals and/or data and/or radiofrequency (RF) signals receiving at least one central contact intended to be connected to a wire of a cable, including a housing for receiving and holding an electrical insulating block, and, on its outer periphery, at least two different lamellae extending along the longitudinal axis (X) and the profiles of which in longitudinal section are different to one another, one of the two lamellae including at least one outwardly protruding bump, so as to form a point of electrical contact, the other of the two lamellae not having an outward bump, the two lamellae being connected to one another via each of their longitudinal ends by a peripheral band.

### CROSS-REFERENCE TO RELATED APPLICATION

This application claims the benefit of priority to French Application No. 2408284 filed on Jul. 25, 2024, the entire disclosures of which are hereby incorporated herein by reference.

### TECHNICAL FIELD

The present invention relates to the field of electrical and/or data transmission connector technology.

It relates more particularly to an electromagnetic shielding body for a connector in which each central contact is connected, preferably crimped, to a bare end of a wire of an electrical cable.

The invention applies in particular to connector technology for the transmission of data using cables comprising a transmission wire, a pair of transmission wires or several pairs of transmission wires that are shielded or unshielded.

The invention applies more generally to any type of connector technology for the transmission of electrical signals and/or data and/or radiofrequency (RF) signals, including coaxial connectors comprising a single central conductor.

One advantageous application is connector technology for motor vehicles.

### PRIOR ART

In the field of connector technology for the transmission of electrical signals and/or data and/or radiofrequency (RF) signals, RF connectors are known which have an electrical insulating block, in which are received, pre-assembled where applicable, one or more central contacts, each being crimped or intended to be crimped around a bare end of a wire of an electrical cable.

Patent FR3074616B1 discloses a connector of this type with a pre-assembled sub-assembly, which is shown in FIG. 1.

The pre-assembled connector sub-assembly 1 is intended to be connected to and mounted on a cable 2 having wires that are insulated from one another.

The sub-assembly 1 comprises a metal body 10 produced by cutting and rolling, forming an electromagnetic shielding body or earthing body, which can usually be referred to as an earth contact.

This shielding body 10 holds inside it an electrical insulating block 11 into which are inserted central contacts 12, 13 comprising crimping end parts 14, 15 which extend, being positioned protrudingly towards the rear of the insulating block 11. The central contacts 12, 13 are electrically insulated from the shielding body 10 by means of the electrical insulating block 11.

These end parts 14, 15 of the central contacts 12, 13 are crimped around bare ends of cores of wires of an electrical cable.

This crimping may take place before or after the central contacts 12, 13 are plugged into the insulating block 11 in a reference position which must be as accurate as possible relative to the sub-assembly comprising the shielding body and the insulation.

The shielding body 10 comprises flexible tabs or lamellae 100 forming electrical earthing tabs, distributed on its periphery at the front, that are parallel to one another.

Each of the tabs 100 includes an outwardly protruding bump 101, which makes electrical contact with an electrically conductive body forming electromagnetic shielding of a complementary connector.

Several shapes, arrangements and configurations of lamellae have been proposed for a shielding body of a connector.

Patent application EP3783754A1 thus discloses an earthing body having flexible lamellae, which are distributed on the periphery of the body, and which include a point of electrical contact, in order to establish an electrical connection with the complementary earth contact, once the complementary connectors have been coupled. The lamellae of a first group each have a free end and a fixed end, while the lamellae of a second group each have two fixed ends. Effectively, the many points of electrical contact generate a coupling force between connectors which is high, especially as the lamellae of the second group have a U or V shape oriented inward and coming into contact with the insulation, something which adds an extra stress upon coupling and therefore an additional force. To limit this high coupling force, by virtue of to their free end, the lamellae of the first group make it possible to have a coupling load that is lower compared to the lamellae of the second group, but at the expense of increased fragility. Moreover, the profile of the lamellae of the second group is particularly difficult to produce, with inward bending and outward pressing.

U.S. Pat. No. 10,224,659B2 discloses an earthing body comprising several series of lamellae distributed on the periphery of the body and each comprising an external bump as point of electrical contact with a complementary earthing body. In order to reduce the coupling forces generated by the concomitant deformation of the bumps, this patent proposes axially offsetting some of the bumps relative to the others. At the start of coupling, this means that centring is ensured only by two diametrally opposite bumps, which can lead to the two complementary connectors not being entirely coaxial. Moreover, in patent EP4193427B1, the lamellae serve to centre the electrical insulation received inside the earthing body, when the latter is inserted in that of the complementary connector. The coupling loads are therefore somewhat increased owing to the rigidity of the lamellae applied both against the complementary earthing body and the insulation to be centred.

Thus, the earthing bodies, more generally the electromagnetic shielding bodies of the connectors found in the prior art have the major drawback of high coupling loads, owing to the presence and the deformation of multiple points of contact in the form of bumps, which come into contact with the earthing body of the complementary connector. This effect is exacerbated in earthing bodies in which the lamellae bearing the contact bumps are attached by their two ends to a cylindrical portion of the body, because this enhances their inherent rigidity and, thereby, the contact loads.

There is therefore a need to further improve earthing bodies, more generally electromagnetic shielding bodies, of connectors, notably in order to reduce the coupling loads when coupling with complementary connectors.

The invention aims to meet all or some of this need.

### DISCLOSURE OF THE INVENTION

To this end, the invention relates, according to one of its aspects, to an electrically conductive body having a longitudinal axis (X), forming an electromagnetic shielding body for a connector for the transmission of electrical signals and/or data and/or radiofrequency (RF) signals receiving at least one central contact intended to be connected to a wire of a cable, comprising a housing for receiving and holding an electrical insulating block, and, on its outer periphery, at least two different lamellae extending along the longitudinal axis (X) and the profiles of which in longitudinal section are different to one another, one of the two lamellae comprising at least one outwardly protruding bump, so as to form a point of electrical contact, the other of the two lamellae not having an outward bump, the two lamellae being connected to one another via each of their longitudinal ends by a peripheral band.

Advantageously, the at least two lamellae of different profiles have an identical neutral axis length. The term “neutral axis” means here and in the context of the invention the part of the thickness of material which is neither extended nor shortened, upon deformation of the material, for example by bending or folding. A difference in neutral axis length between the lamellae can give rise to deformation of the earthing/shielding body, when it is being produced by forming (pressing of the bumps, rolling of the body) and when the body is coupled with the body of a complementary connector, wherein the coupling loads give rise to irregular deformation of the earthing/shielding body. Thus, a neutral axis length which is identical, to within manufacturing tolerances, makes it possible to prevent such deformation.

According to an advantageous feature, the peripheral band connecting the front longitudinal ends is provided with at least one longitudinal slot.

According to an advantageous embodiment, the shielding body comprises more than two lamellae, the different lamellae being distributed in an alternating arrangement on the outer periphery of the body.

According to an advantageous variant embodiment, the other of the two lamellae not having an outward bump comprises an inwardly protruding bump.

Advantageously, the inwardly protruding bump is arranged substantially at the same longitudinal level or offset longitudinally relative to the outwardly protruding bump.

Also advantageously, the outwardly protruding bump, and where applicable the inwardly protruding bump has (have) a cylindrical cross section and/or a spherical longitudinal section.

According to an advantageous variant embodiment, the other of the two lamellae not having an outward bump comprises an outwardly protruding flat surface with a transverse dimension smaller than the outwardly protruding bump.

Preferably, the shielding body is in one piece, preferably produced by cutting and rolling.

Also preferably, the material from which the shielding body is made is selected from copper, copper alloy, stainless steel.

The shielding body may have a circular or oblong cross section.

The invention also relates to a sub-assembly for a connector, comprising:
at least one central contact, intended to be connected, preferably crimped, to the end of a wire of an electrical cable,
an electrical insulating block comprising at least one cavity into which the central contact is plugged,
an electromagnetic shielding body as described above, the housing of which receives and holds the electrical insulating block.

The invention also relates to a connector, comprising:
at least one sub-assembly as described above,
a casing, preferably made of electrically insulating material, in which the sub-assembly is received and fixed.

The invention lastly relates to a method for producing an electrically conductive body forming an electromagnetic shielding body for a connector for the transmission of electrical signals and/or data and/or radiofrequency (RF) signals, receiving at least one central contact intended to be connected to a wire of a cable, the method comprising the following steps:
i/ supplying a flat metal strip;
ii/ cutting, when flat, slots each defining a space between two adjacent lamellae;
iii/ forming at least one first lamella comprising a bump intended to protrude outwards from the body;
iv/ forming at least one second lamella having a profile of longitudinal section different to that of the first lamella and not having a bump, and preferably having a neutral axis length that is identical to that of the first lamella;
v/ rolling the metal strip about the longitudinal axis so as to form the body;
wherein steps iii/ and iv/ may be carried out simultaneously or sequentially, in any order.

Thus, the invention consists essentially of an earthing/electromagnetic shielding body of a connector having at least one central contact, at least two lamellae having a profile of different longitudinal section, one of which comprises a bump projecting outwards, which is intended to constitute a point of electrical contact with the earthing/shielding body of an external connector.

The other of the two lamellae does not have a bump especially for forming a point of electrical contact.

By thus reducing the number of electrical contact bumps relative to an earthing/shielding body according to the prior art, in which all of the lamellae have an electrical contact protrusion, the coupling loads between complementary connectors are reduced. Furthermore, for the same number of lamellae, the electromagnetic shielding induced by the body according to the invention is preserved.

Moreover, by making the lamellae different but with an identical axis length, there is no risk of deformation of the shielding body during the forming operations (pressing of the bumps, rolling of the contact body) required to produce it and when it is being coupled with an earthing body of a complementary connector.

Thus, the advantages of the invention compared to the shielding bodies of connectors found in the prior art are many, and in particular:
a reduction in the coupling loads between a connector comprising a shielding body according to the invention and a complementary connector;
homogeneous contact loads resulting from the outwardly oriented bumps, because, during coupling, the body deforms homogeneously owing to the alternating arrangement of the two different lamella profiles;
better hyperfrequency performance by optimizing the distances for electrical impedance, induced by the alternating arrangement of different lamellae, respectively closer to and further away from the connector central contact;
a reduction in the clearance between the earthing/shielding body and the electrical insulating block of the connector, with no load pressing on the insulating block from the lamella (e) not having an external bump, whether the connector is in the coupled or uncoupled state;
better quality of manufacturing thanks to the homogeneity of the shapes obtained by a neutral axis that is identical for all the lamellae, which allows better rolling of the body when it is being manufactured.

Further advantages and features of the invention will become clearer on reading the detailed description of examples of the implementation of the invention, provided by way of non-limiting illustration, with reference to the following figures.

### BRIEF DESCRIPTION OF THE DRAWINGS

FIG. 1 is a perspective view of an example of a connector sub-assembly having central contacts to be crimped, comprising an electromagnetic shielding body according to the prior art.

FIG. 2 is a perspective view of a coaxial connector sub-assembly having a central contact comprising an electromagnetic shielding body of the invention, and a cable, in a configuration in which the cable is crimped on the ferrule and the central contact of the sub-assembly.

FIG. 3 is a perspective view of another coaxial connector sub-assembly having a single central contact comprising an electromagnetic shielding body of the invention, and a cable, in a configuration in which the cable is crimped on the ferrule and the central contact of the sub-assembly.

FIG. 4 is an exploded view of FIG. 2 in a configuration before crimping.

FIG. 5 is another perspective view of FIG. 2.

FIG. 6 is an end-on view of a coaxial connector sub-assembly having a central contact comprising an electromagnetic shielding body of the invention, and a cable, in a configuration in which the cable is crimped on the ferrule and the central contact of the sub-assembly.

FIGS. 6A, 6B, 6C are views in longitudinal section respectively along A-A, B-B, C-C in FIG. 6.

FIG. 7 is a side view of an electromagnetic shielding body according to the invention.

FIG. 7F is a view in cross section along F-F in FIG. 7.

FIG. 8 is a view in cross section along F-F in FIG. 7 depicting a connector with a shielding body according to the invention showing the different distances between the lamellae and the central contact.

FIG. 9 is a view in longitudinal section depicting a connector with a shielding body according to the invention in a configuration coupled with a complementary connector.

FIGS. 9I, 9J, 9K are views in cross section respectively along I-I, J-J, K-K in FIG. 9.

FIG. 10 is a perspective view of a first variant of an electromagnetic shielding body according to the invention.

FIG. 11 is an end-on view of FIG. 10.

FIGS. 11A and 11B are views in longitudinal section respectively along A-A, B-B in FIG. 11.

FIG. 12 is a perspective view of a second variant of an electromagnetic shielding body according to the invention.

FIG. 13 is an end-on view of FIG. 12.

FIGS. 13A and 13B are views in longitudinal section respectively along A-A, B-B in FIG. 13.

FIG. 14 is a perspective view of a third variant of an electromagnetic shielding body according to the invention.

FIG. 15 is an end-on view of FIG. 14.

FIGS. 15A and 15B are views in longitudinal section respectively along A-A, B-B in FIG. 15.

FIG. 16 is a perspective view of a fourth variant of an electromagnetic shielding body according to the invention.

FIG. 17 is an end-on view of FIG. 16.

FIGS. 17A and 17B are views in longitudinal section respectively along A-A, B-B in FIG. 17.

FIG. 18 is a perspective view of a fifth variant of an electromagnetic shielding body according to the invention.

FIG. 19 is an end-on view of FIG. 18.

FIGS. 19A and 19B are views in longitudinal section respectively along A-A, B-B in FIG. 19.

FIG. 20 is a perspective view of a sixth variant of an electromagnetic shielding body according to the invention.

FIG. 21 is an end-on view of FIG. 20.

FIGS. 21A and 21B are views in longitudinal section respectively along A-A, B-B in FIG. 21.

FIG. 22 is a perspective view and view in partial longitudinal section of a connector, the casing of which receives a connector sub-assembly with an electromagnetic shielding body according to the invention, as connected to a cable.

FIG. 23 is a perspective view of a connector sub-assembly having two central contacts comprising an electromagnetic shielding body of the invention, and a two-wire cable, in an intermediate mounting configuration.

### DETAILED DESCRIPTION

Throughout the present application, the terms “front” and “rear” should be understood with reference to the face of connection of an electromagnetic shielding body and a connector sub-assembly according to the invention. Thus, the front portion of a component of a connector is that intended to be closest to the complementary connector with which the connector is intended to be connected. Thus, the front face of the electrical insulating block of the connector is that intended to be in contact with that of a complementary connector and the front part of a central contact is that intended to be coupled with a central contact of the complementary connector.

For the sake of clarity, the same reference numeral is used for the same element of a sub-assembly according to the prior art and a sub-assembly according to the invention.

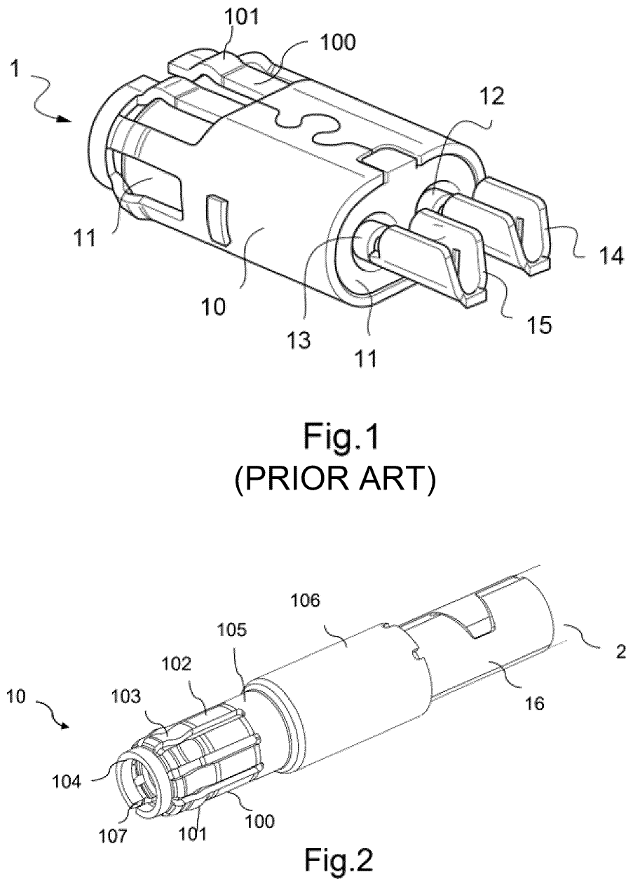

FIG. 1 has already been described in detail in the preamble. It will therefore not be discussed further here.

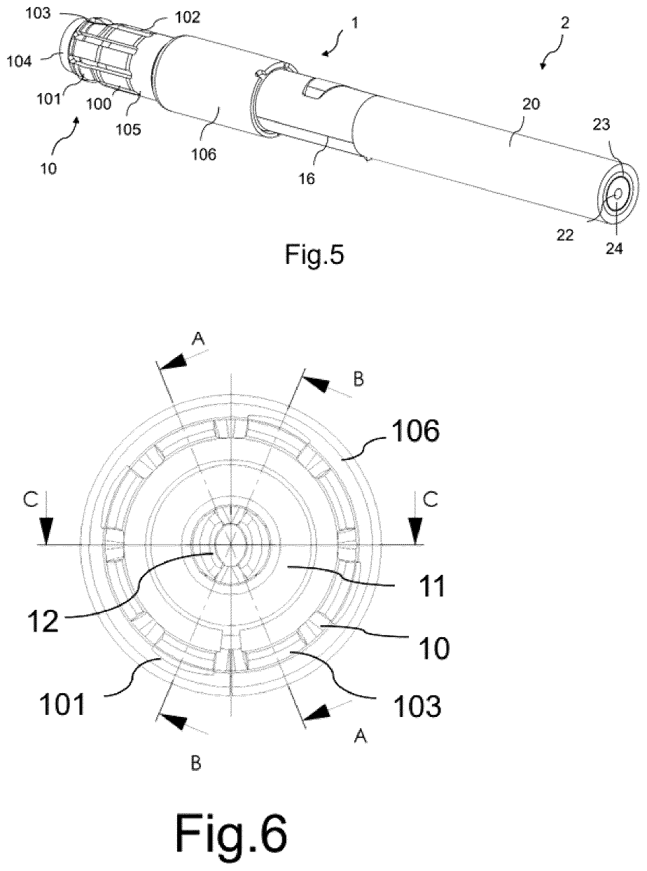

FIGS. 2, 4 and 5 show a coaxial connector sub-assembly 1 comprising an earthing/electromagnetic shielding body according to the invention.

The connector sub-assembly 1 extends along a longitudinal axis X, and is pre-assembled, since it comprises an electrical insulating block 11 pre-assembled in a front metal body, notably one-piece 10, forming an electromagnetic shielding body according to the invention.

The sub-assembly 1 is connected to and mounted on a coaxial cable 2 with an insulated wire.

The cable 2 comprises an outer sheath 20 made of electrically insulating material and an electrical conductor 22, insulated from the outside by the outer sheath 20.

The cable 2 further comprises a metal braid 23 for electromagnetic shielding surrounding the insulated conductor.

A dielectric 24 is interposed between the core 21 of the insulated conductor and the metal braid 23.

The one-piece metal body 10 forming the electromagnetic shielding body is produced by cutting and rolling, and ensures electrical earthing continuity and impedance matching.

A central contact 12 comprising a crimping end part 14 which extends, notably positioned protrudingly, towards the rear of the insulating block 11, is inserted in a cavity 114, 115 of the electrical insulating block 11 provided for this purpose. The single central contact 12 may be formed from a one-piece metal blank produced by a technique of cutting and rolling, preferably from a continuous strip 18.

The end part 14 of the central contact 12 is crimped around a bare end of a core 22 of a wire of the coaxial electrical cable 2.

In the example illustrated, the central contact 12 is of female type. A central contact of male type may also be envisaged.

The metal body 10 forming electromagnetic shielding according to the invention has a generally circular cross section and comprises first of all a housing for receiving and holding the electrical insulating block 11. The cross section may also be of oblong shape.

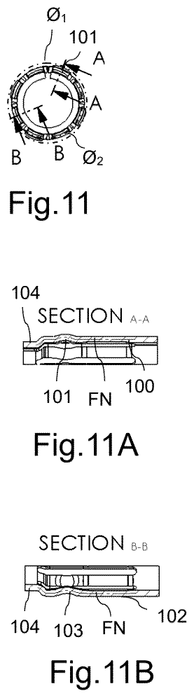

On its outer periphery, the body 10 comprises at least two different lamellae 100, 102 that are parallel to one another and the profiles of which in longitudinal section are different to one another but with an identical neutral axis length. This neutral axis is referenced FN and depicted in dotted lines in FIGS. 11A, 11B, 13A, 13B, 15A, 15B, 17A, 17B, 19A 19B, 21A and 21B.

The longitudinal section of each of the lamellae 100 and 102 has at least one deformation which extends radially. In other words, the lamellae 100 and 102 each have a longitudinal profile which is differentiated radially from the rest of the electromagnetic shielding body.

The different lamellae 100 and 102 are distributed in an alternating arrangement on the outer periphery of the body 10.

One of the two lamellae 100 comprises at least one outwardly protruding bump 101, so as to form a point of electrical contact with a metal shielding body 30 of a complementary connector 3. The lamella 100 may have a constant thickness along its length, or include one or more areas of smaller thickness, for example by coining during the operation of cutting/forming of the body. As shown in FIGS. 2 to 4, the bump 101 may have a cylindrical cross section and a spherical longitudinal section.

The other of the two lamellae 102 does not have an outward bump.

As shown in FIGS. 2 to 4, this lamella may be provided with a bump 103 protruding inward on the body. This bump 103 may have a cylindrical cross section. This bump 103 reduces the clearance between an outer face of the insulating block 11 and the inner face of the bump 103, and ensures better centring of the insulating block 11 in the body 10 and hence good coaxiality. The bump 103 may have a non-zero radial clearance with the outer face of the insulating block in the uncoupled and coupled position of the connector. Alternatively, the bump 103 may be flush, in the absence of a load, with the outer face of the insulating block 11, in particular in the coupled position. This bump 103 may be arranged substantially at the same longitudinal level or offset longitudinally relative to the outwardly protruding bump. Owing to the small distance with respect to the central contact 12, the bump 103 allows compensation of characteristic impedance relative to the bump 101, which is radially further away from the central contact 12.

Compared to a shielding body according to the prior art, the body 10 according to the invention having a smaller number of bumps 101 which will constitute points of electrical contact, makes it possible to reduce the coupling loads between the connector incorporating the body 10 and a complementary connector 3. Moreover, for the same number of lamellae, electromagnetic shielding of the body 10 is preserved.

The front longitudinal ends of all the lamellae 100, 102 are connected to one another by a front peripheral band 104, notably in the shape of a cylinder. This front band 104 makes it possible to pre-centre the body 10 at the start of coupling with a complementary shielding body 30.

The rear longitudinal ends of all the lamellae 100, 102 are connected to one another by a rear peripheral band 105, notably in the shape of a cylinder which is closed on itself.

The attachment of the lamellae 100, 102 at both ends to a cylindrical shape 104, 105 makes it possible to stiffen said lamellae, protect them from mishandling, limit openings detrimental to shielding against EMI (Electro Magnetic Interference), RF, etc.

In the example shown, the electromagnetic shielding body 10 comprises a cylinder 106 which is closed on itself in the rear extension of the rear peripheral band 105.

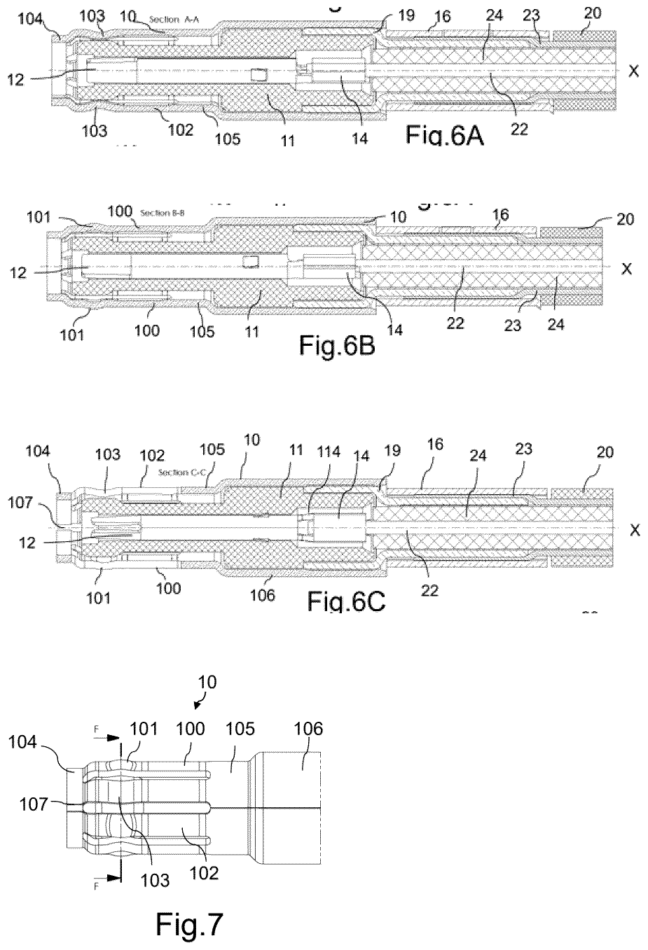

As shown in FIGS. 2 and 6C, the peripheral band 104 connecting the front longitudinal ends may be provided with at least one longitudinal slot 107.

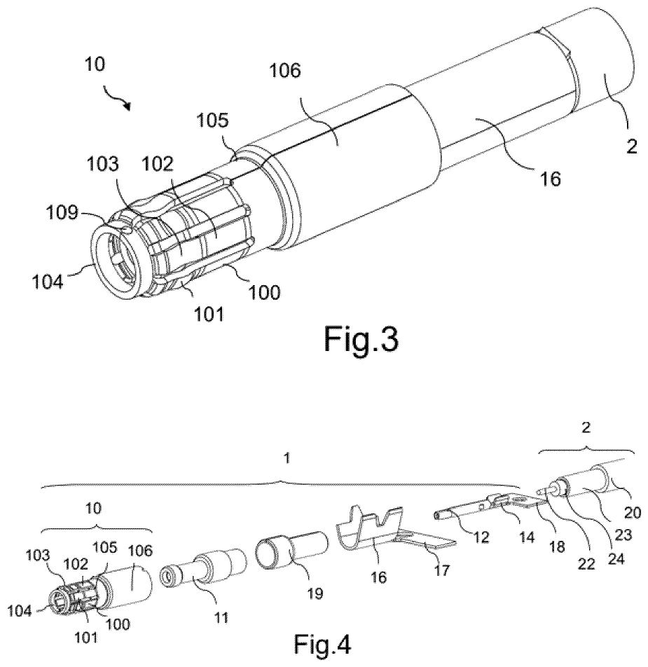

Alternatively, as shown in FIG. 3, the front peripheral band 104 may have adjoining edges welded to one another. A spot weld 109 is shown in FIG. 3.

The sub-assembly 1 moreover comprises a crimping ferrule 16.

As shown in FIG. 4, the ferrule 16 generally has a partially hollow cylindrical shape and may be formed from a one-piece metal blank produced by a technique of cutting and rolling preferably from a continuous strip 17.

Lastly, the sub-assembly 1 may comprise a rear metal shielding body 19 consisting of a hollow cylinder which is closed on itself, with two different diameters, one in the extension of the other. This rear body 19 is inserted at the rear of the front body 10.

FIG. 6 shows a connector sub-assembly 1 as mounted on and connected to the cable 2 with its central contact 12 crimped on the central contact 22 of the cable 2.

The rear body 19 is inserted in the front body 10, being in contact with and around the insulating block 11 and the dielectric 24 of the cable 2.

The ferrule 16 is crimped on the metal braid 23 of the cable 2, itself around the rear electromagnetic shielding body 19.

FIG. 6A in section along A-A makes it possible to see the profile of the lamellae 102 with an internal bump 103 and the limited clearance that it defines with the insulating block 11. FIG. 6B in section along B-B makes it possible to see the profile of the lamella 100 with an external bump 101 which forms a point of electrical contact.

FIG. 6C in section along C-C makes it possible to see the slot which separates a lamella 100 with an external bump 101 and a lamella 102 not having this external bump.

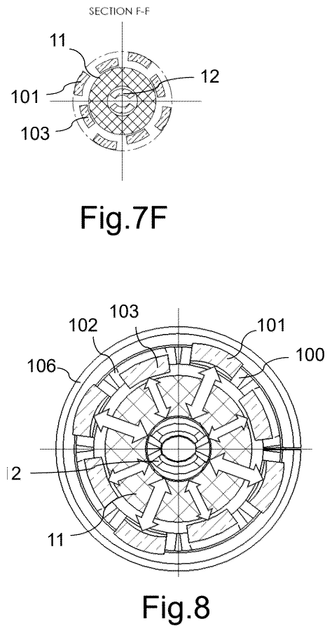

FIG. 7 depicts an electromagnetic shielding body 10 receiving an electrical insulating block 11, the external bumps 101 of the lamellae 100 forming the points of electrical contact, the internal bumps 103 of the lamellae 102 forming points of centring of the insulating block 11.

FIG. 7F in section along F-F shows a circumscribed circle which defines the outer surface of the external bumps 101 of electrical contact and the internal bumps 103 of the lamellae 102 which are closest to the insulating block 11 in order to centre the latter.

FIG. 8 shows, in a view in cross section, a connector sub-assembly 1 according to the invention. In this FIG. 8, the double arrows show the distances between the central contact 12 and the lamellae 100, 102 of the earthing body 10, making it possible to calculate the characteristic impedance. As can thus be seen, with the external bumps 101, in other words those furthest away from the central contact 12, the impedance is increased, whereas with the internal bumps 103, in other words those closest to the central contact 12, the impedance is reduced. In other words, the internal bumps 103 compensate for the increased impedance of the external bumps 101.

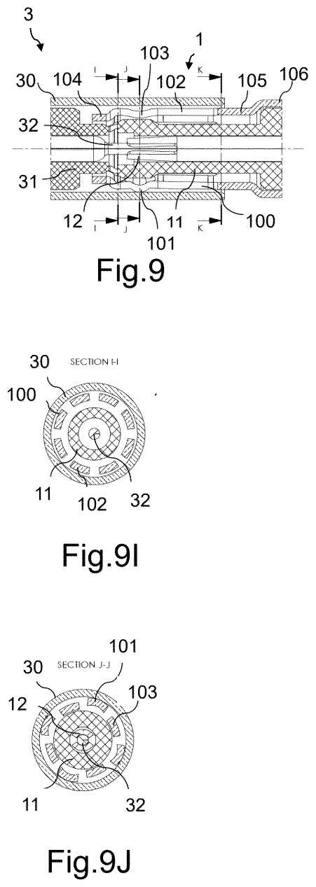

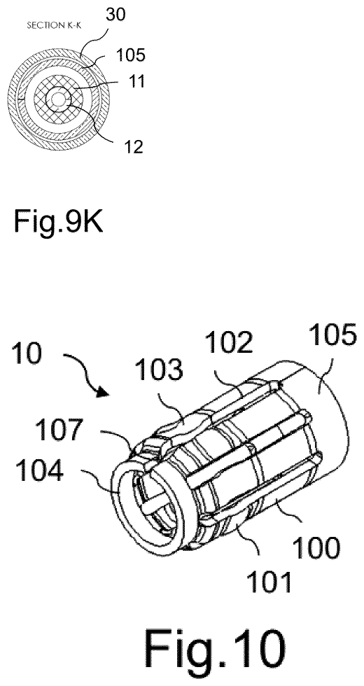

FIG. 9 shows, in a view in longitudinal section, a connector sub-assembly 1 according to the invention in a position in which it is coupled with a complementary connector 3.

In this coupled configuration, the external bumps 101 are in contact with the earthing body 30 of the complementary connector 3.

The internal bumps 103 are not in contact with the insulating block 11, but limit its movement by a guide clearance which is small or even zero in the absence of a pressing load.

As can be seen in FIG. 9I in section along I-I, at a longitudinal level to the front of the external bumps 101, none of the lamellae 100, 102 is in contact with the earthing body 30.

FIG. 9J in section along J-J at the external bumps 101 and at the internal bumps 103, shows that only the lamellae 100 with the external bumps 101 are in mechanical, and therefore electrical contact with the earthing body 30.

As can be seen in FIG. 9K in section along K-K, at a longitudinal level to the rear of the lamellae 100, 102, the cylindrical envelopes 30, 105 of the earthing bodies still have a non-zero clearance.

Various different shapes, dimensions and arrangements of lamellae 100 and 102 may be envisaged, depending on the manufacturing constraints or the required electrical or mechanical performance.

FIGS. 10, 11, 11A and 11B show a first variant, with four lamellae 100 distributed in an alternating arrangement with four lamellae 102 on the outer periphery of the body 10. A lamella 100 has a rear part with a smaller thickness and comprises an external bump 101 of spherical section. A lamella 102 has a rear part with a smaller thickness and comprises an internal bump 103 arranged at the same longitudinal level as the external bump 101.

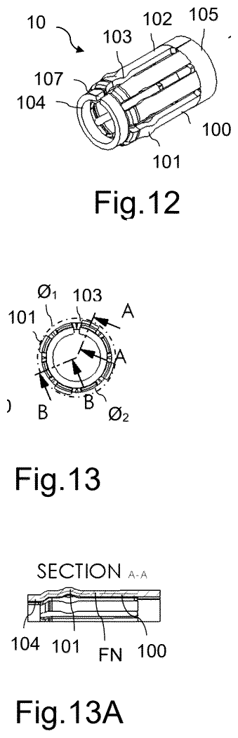

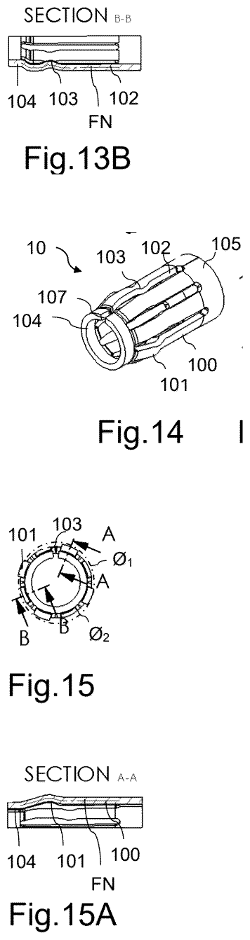

FIGS. 12, 13, 13A and 13B show a second variant, with four lamellae 100 distributed in an alternating arrangement with four lamellae 102 on the outer periphery of the body 10. A lamella 100 has a constant thickness and comprises an external bump 101 of simple shape, notably of cylindrical cross section. A lamella 102 has a constant thickness and comprises an internal bump 103 arranged at the same longitudinal level as the external bump 101.

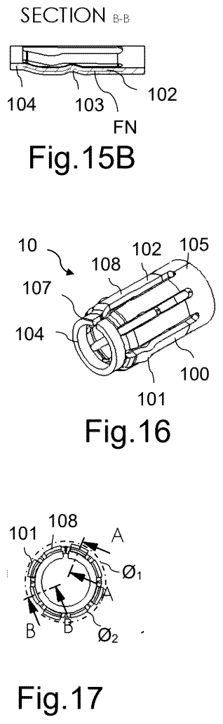

FIGS. 14, 15, 15A and 15B show a third variant, with four lamellae 100 distributed in an alternating arrangement with four lamellae 102 on the outer periphery of the body 10. A lamella 100 has a constant thickness and comprises an external bump 101 of simple shape, notably of cylindrical cross section, with an insertion slope. A lamella 102 has a constant thickness and comprises an internal bump 103 arranged at a longitudinal level offset relative to the external bump 101.

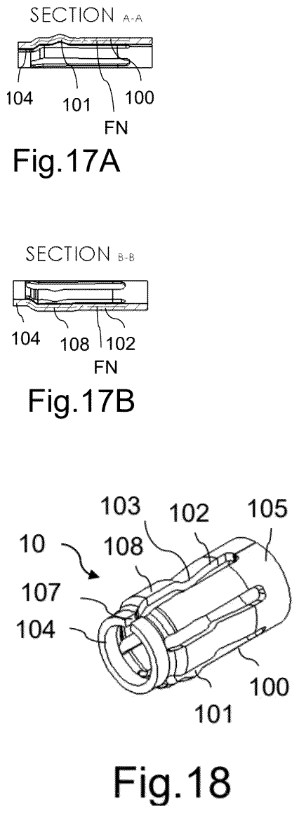

FIGS. 16, 17, 17A and 17B show a fourth variant, with four lamellae 100 distributed in an alternating arrangement with four lamellae 102 on the outer periphery of the body 10. A lamella 100 has a constant thickness and comprises an external bump 101 of simple shape, notably of cylindrical cross section. A lamella 102 has a constant thickness and comprises a flat surface 108 which protrudes outwards but without a zone of possible electrical contact with the complementary earthing body 30, after coupling. This flat surface 108 allows guidance of the earthing body 10 in the complementary earthing body 30 when they are coupled. This flat surface 108 is arranged at the same longitudinal level as the external bump 101.

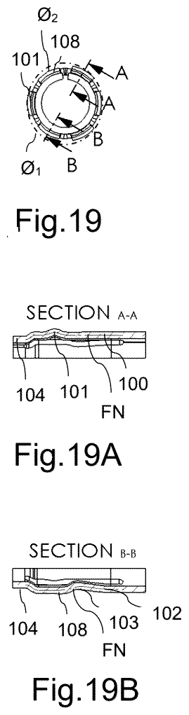

FIGS. 18, 19, 19A and 19B show a fifth variant, with three lamellae 100 distributed in an alternating arrangement with three lamellae 102 on the outer periphery of the body 10. These lamellae 100, 102 are therefore wider and more robust than those in previous variants for the same diameter of earthing body 10. A lamella 100 has a constant thickness and comprises an external bump 101 of simple shape. A lamella 102 has a constant thickness and comprises a flat surface 108, which protrudes outwards but without a zone of possible electrical contact with the complementary earthing body 30. This flat surface is arranged at the same longitudinal level as the external bump 101. At the rear of the flat surface 108, an internal bump 103 is positioned at a longitudinal level offset relative to the external bump 101.

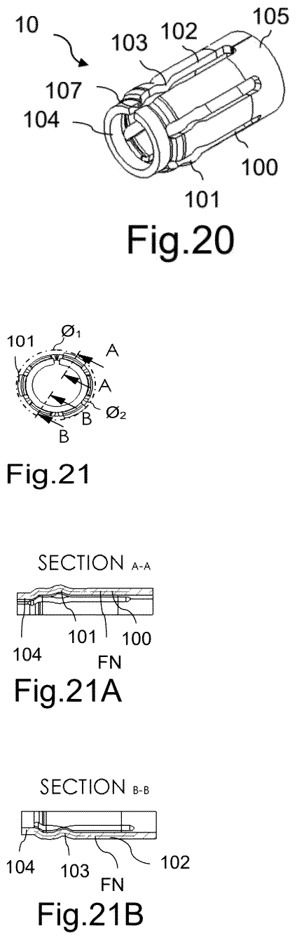

FIGS. 20, 21, 21A and 21B show a sixth variant, with three lamellae 100 distributed in an alternating arrangement with three lamellae 102 on the outer periphery of the body 10. These lamellae 100, 102 are therefore wider and more robust than those in previous variants with four lamellae 100 and four lamellae 102, for the same diameter of earthing body 10. A lamella 100 has a constant thickness and comprises an external bump 101 of simple shape. A lamella 102 has a constant thickness and comprises an internal bump 103 arranged at the same longitudinal level as the external bump 101.

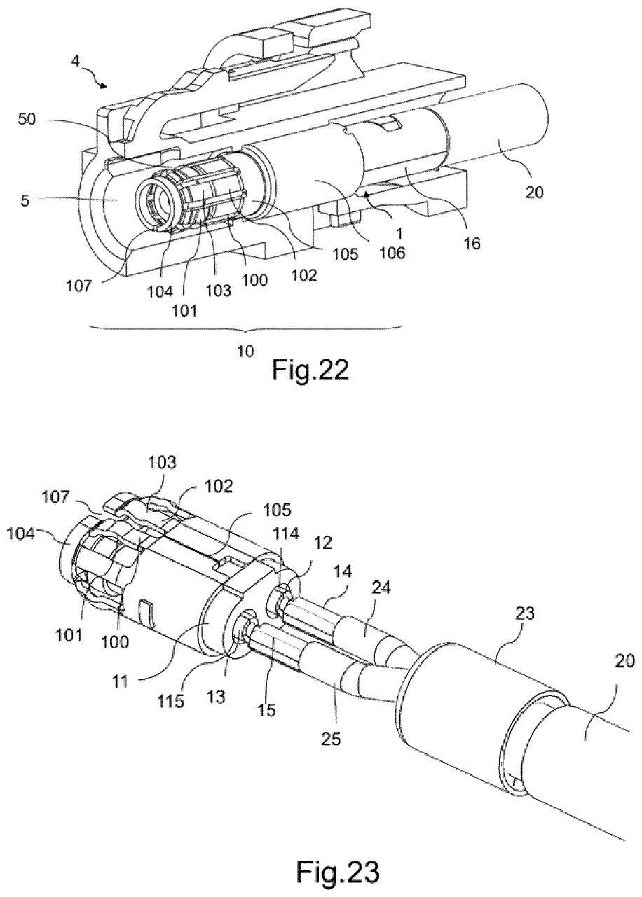

A sub-assembly 1 which has just been described is received and fixed in the housing 50 of an adapted casing 5 so as to form a connector 4 as shown in FIG. 22, with the central contact 12 already crimped by its crimping part 14 to the bare end of the wire 21 of the cable 2. The sub-assembly 1 is centred in the housing 50 of the casing 5 by the cylinder 106.

FIG. 23 shows an embodiment with a connector sub-assembly 1 with an earthing body 10 according to the invention of oblong cross section, which receives an insulating block 11 in which are inserted two central contacts 12, 13 to be crimped, each via their crimping part 14, 15 to the bare end of a wire insulated by a sheath 24, 25 of a cable 2 with a metal braid 23.

Thus, in this embodiment with two central contacts, the electrical cable comprises two insulated wires, each insulated wire comprising a conductive core 21 surrounded by a dielectric 24, 25, the two insulated wires being surrounded by a metal braid 23. The metal braid may be surrounded by an outer insulation sheath 20.

As shown in the various figures illustrating the variants, the outside diameter Ø₁ defined by the set of outward bumps 101 of the lamellae 100 is always greater than the outside diameter Ø₂ defined by the set of reliefs or not of the lamellae 102, whatever their shape (internal bump 103, flat surface 108 or the like). This ensures that the points of electrical contact between the earthing body 10 and a complementary earthing body 30 are provided only by the external bumps 101 of the lamellae 100. In other words, the diameter Ø₁ is always greater than the inside diameter (or internal profile) of the complementary earthing body 30, and the diameter Ø₂ is always smaller than the inside diameter (or internal profile) of the complementary earthing body 30.

To produce an electromagnetic shielding body 10 according to the invention, the following steps are carried out:
i/ supplying a flat metal strip;
ii/ cutting, when flat, slots each defining a space between two adjacent lamellae 100, 102;
iii/ forming at least one lamella 100 comprising a bump 101 intended to protrude outwards from the body;
iv/ forming at least one lamella 102 having a profile of longitudinal section different to that of the first lamella and not having a bump, and preferably having a neutral axis length that is identical to that of the first lamella;
v/ rolling the metal strip about the longitudinal axis so as to form the body 10.

Steps iii/ and iv/ may be carried out in any order.

Steps iii/ and iv/ may be carried out simultaneously or sequentially.

Other variants and improvements may be provided without thereby departing from the scope of the invention.

The connector sub-assembly 1 may be configured for plugging in more than two central contacts to be plugged into the same electrical insulating block, the shielding body 10 with different lamellae 100, 102 being adapted accordingly.

1. An electrically conductive body having a longitudinal axis (X), forming an electromagnetic shielding body for a connector for the transmission of electrical signals and/or data and/or radiofrequency signals receiving at least one central contact intended to be connected to a wire of a cable, comprising a housing for receiving and holding an electrical insulating block, and, on its outer periphery, at least two different lamellae extending along the longitudinal axis (X) and the profiles of which in longitudinal section are different to one another, one of the two lamellae comprising at least one outwardly protruding bump, so as to form a point of electrical contact, the other of the two lamellae not having an outward bump, the two lamellae being connected to one another via each of their longitudinal ends by a peripheral band.

2. The electromagnetic shielding body according to claim 1, wherein the at least two lamellae of different profiles have an identical neutral axis length.

3. The electromagnetic shielding body according to claim 1, wherein the peripheral band connecting the front longitudinal ends is provided with at least one longitudinal slot.

4. The electromagnetic shielding body according to claim 1, comprising more than two lamellae, the different lamellae being distributed in an alternating arrangement on the outer periphery of the body.

5. The electromagnetic shielding body according to claim 1, wherein the other of the two lamellae not having an outward bump comprises an inwardly protruding bump.

6. The electromagnetic shielding body according to claim 5, wherein the inwardly protruding bump is arranged substantially at the same longitudinal level or offset longitudinally relative to the outwardly protruding bump.

7. The electromagnetic shielding body according to claim 1, wherein the outwardly protruding bump, has a cylindrical cross section and/or a spherical longitudinal section.

8. The electromagnetic shielding body according to claim 1, wherein the other of the two lamellae not having an outward bump comprises an outwardly protruding flat surface with a transverse dimension smaller than the outwardly protruding bump.

9. The electromagnetic shielding body according to claim 1, wherein the shielding body is in one piece.

10. The electromagnetic shielding body according to claim 1, wherein the material from which it is made is selected from copper, copper alloy, stainless steel.

11. A sub-assembly for a connector, comprising:
at least one central contact, intended to be connected, to the end of a wire of an electrical cable,
an electrical insulating block comprising at least one cavity into which the central contact is plugged, and
the electromagnetic shielding body according to claim 1, the housing of which receives and holds the electrical insulating block.

12. A connector comprising:
the sub-assembly according to claim 11, and
a casing in which the sub-assembly is received and fixed.

13. A method for producing an electrically conductive body forming an electromagnetic shielding body for a connector for the transmission of electrical signals and/or data and/or radiofrequency (RF) signals, receiving at least one central contact intended to be connected to a wire of a cable, the method comprising the following steps:
i/ supplying a flat metal strip;
ii/ cutting, when flat, slots each defining a space between two adjacent lamellae;
iii/ forming at least one first lamella comprising a bump intended to protrude outwards from the body;
iv/ forming at least one second lamella having a profile of longitudinal section different to that of the first lamella and not having a bump, and having a neutral axis length that is identical to that of the first lamella;
v/ rolling the metal strip about the longitudinal axis so as to form the body;
steps iii/ and iv/ may be carried out simultaneously or sequentially, in any order.
